(19) United States
(12) Patent Application Publication
(10) Pub. No.: US 2005/0285871 A1
(43) Pub. Date: Dec. 29, 2005

(54) Image-processing circuit, electronic apparatus, and method for processing image

(75) Inventor: Hiroko Tsujiguchi, Kawasaki-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/157,654

(22) Filed: Jun. 21, 2005

(30) Foreign Application Priority Data
Jun. 29, 2004 (JP) 2004-191638

(51) Int. Cl. G09G 5/02; G06F 12/02; G09G 5/39

(52) U.S. Cl. 345/565; 345/531; 345/603

(57) ABSTRACT

An image-processing circuit includes a memory including a data table for a plurality of calculations; a central processing unit executing the calculations; and a memory controller controlling read of data from the data table upon instruction from the central processing unit. The memory controller includes address registers holding a predetermined number of addresses read from the data table for use in a single calculation; data registers corresponding to the address registers and holding data corresponding to the addresses in the address registers; a determination unit determining, with respect to each of the predetermined number of addresses, whether the address for a previous calculation and an address instructed from the central processing unit for a present calculation are the same as each other; and a control unit, when the address for the present calculation is the same as the previous address, reading data from the data register.

### BACKGROUND OF THE INVENTION

1. Field of the Invention

The present invention relates to an image-processing circuit, an electronic apparatus including the image-processing circuit, and a method for processing an image.

2. Description of the Related Art

Hitherto, a variety of high-speed accessing methods of a central processing unit (CPU) to a main memory (methods for storing data and reading it) in an electronic apparatus or an image-processing circuit are proposed.

For example, according to one of the methods, a cache memory is provided in the CPU, and data and addresses read from the main memory by the CPU are held in the cache memory. Discontinuous or random locations of addresses of data to be read can cause a cache miss to occur, which requires a process for newly storing the data (called a fill or refill process (see Japanese Patent Laid-Open No. 5-143456).

An image-processing circuit provided in an electronic apparatus, such as a recording apparatus, performs a color conversion process, such as a tetrahedral interpolation process, for converting an RGB signal of image data to a CMYK signal. In order to perform the interpolation process, a lookup table is provided in a memory (see Japanese Patent Laid-Open No. 2000-22975).

While depending on the numbers of bits of data and colors, the amount of data constituting the lookup table is, for example, on the order of 20 k bites to 40 k bits. As the numbers of bits of the data and colors increases, the size of the table increases dramatically and exceeds the size of the cache memory.

With the tetrahedral interpolation process, data is read from four addresses for performing a single calculation. The four addresses correspond to respective lattice points and depend on color information (for example, an R-component, a G-component, and a B-component) of each pixel serving as an input value. The color information depends on a content of image data to be processed. Accordingly, the color information sometimes has different values for one pixel to another and sometimes the same value for a plurality of pixels.

With the above-described reasons, use of a cache memory causes occurrence of cache miss when color information has different values from one pixel to another. Hence, a fill process is performed every occurrence of cache miss, thereby resulting in reduction in a throughput of an image process.

In the meantime, with a technique for reducing the number of access times to the main memory, when an address accessing to the main memory is the same as that accessing to the main memory last time, data is read from data registers disposed in a main memory controller, merged, and stored (see Japanese Patent Laid-Open No. 6-119238).

Unfortunately, an invention of this technique is made under presumption that a storage process is repeatedly performed for a single address and is not applicable to a control with which read processes directed to a plurality of addresses in a main memory, such as the above-described tetrahedral interpolation process, are performed when a single calculation is performed, thereby resulting in failure in effectively performing the calculation.

### SUMMARY OF THE INVENTION

The present invention provides an image-processing circuit reading data from a plurality of addresses of a main memory and effectively performing a calculation for processing an image.

In accordance with one aspect of the present invention, an image-processing circuit includes (1) a memory including a data table for a plurality of calculations, (2) a central processing unit executing the plurality of calculations, and (3) a memory controller controlling read of data from the data table upon receiving an instruction from the central processing unit. The memory controller includes (a) address registers holding a predetermined number of addresses read from the data table for use in a single calculation, (b) data registers corresponding to the respective address registers and holding data corresponding to the addresses held in the address registers, (c) a determination unit determining, with respect to each of the predetermined number of addresses, whether the address held in the address registers for a previous calculation and an address instructed from the central processing unit for a present calculation are the same as each other, and (d) a control unit, when the determination unit determines that the address for the present calculation is the same as the previous address, reading data from the data register corresponding to the address register holding the address, and, when the determination unit determines that the address for the present calculation is different from the previous address, reading data from the memory. The central processing unit executes the plurality of calculations on the basis of data received from the memory controller.

In another aspect of the present invention, a method for processing an image using (1) a memory including a data table for a plurality of calculations, (2) a central processing unit executing the plurality of calculations, and (3) a memory controller controlling read of data from the data table upon receiving an instruction from the central processing unit. The method includes the steps of (a) outputting a predetermined number of address information to be read to the memory on the basis of inputted color space information, (b) determining, with respect to each of the predetermined number of addresses, whether the address used in the previous calculation and an address instructed from the central processing unit for a present calculation are the same as each other, (c) reading data, with respect to the addresses which are determined as being the same or different from the previous address in the determining step, from a data register corresponding to an address register holding the address and from the memory respectively, and (d) performing the plurality of calculations on the basis of the data read in the reading step.

Further features of the present invention will become apparent from the following description of exemplary embodiments with reference to the attached drawings.

### BRIEF DESCRIPTION OF THE DRAWINGS

FIG. 1 is a block diagram of an electronic apparatus according to a first embodiment.

FIG. 2 is a process flow of the apparatus according to the first embodiment.

FIG. 3 illustrates memory access.

FIG. 4 illustrates image process blocks of the electronic apparatus.

FIG. 5 is a process flow of a tetrahedral interpolation of the apparatus according to the first embodiment.

FIG. 6 illustrates timings of processes in the first embodiment.

FIG. 7 is a block diagram of an electronic apparatus according to a second embodiment.

FIG. 8 illustrates a color space in each of the first and second embodiments.

FIG. 9 is a process flow of the apparatus according to the second embodiment.

FIG. 10 is a perspective view of a recording apparatus according to each of the first and second embodiments.

### DESCRIPTION OF THE EMBODIMENTS

Embodiments of the present invention will be described with reference to the attached drawings.

### First Embodiment

FIG. 1 is a block diagram of an electronic apparatus such as a recording apparatus according to the present embodiment. As shown in FIG. 1, the electronic apparatus includes a central processing unit (CPU) 1, a main memory 2 (e.g., an SD-RAM), and a main memory controller 3 disposed in an application specific integrated circuit (ASIC). The CPU 1 includes a cache memory 13. The example memory capacity of the cache memory for holding data is about 4 k bites.

The main memory 2 includes a lookup table (LUT) 21 for a tetrahedral interpolation and an area 22 for storing a computed result. The memory capacity of the lookup table (LUT) 21 is about 30 k bites.

The main memory controller 3 includes address registers 4, a comparator 5, a gate circuit 6, a direct memory access (DMA) unit 7, a register 8 activating the DMA unit 7, data registers 9, a register 10 indicating whether data has been read, and a register 11 holding a compared result.

The address registers 4 hold addresses from the CPU 1. In this case, the main memory controller 3 includes four registers so as to hold four addresses for performing a tetrahedral interpolation.

The comparator 5 (comparing circuit) compares addresses to be read from the lookup table (LUT) 21 for performing the tetrahedral interpolation on the basis of instruction of the CPU 1 with those held in the address registers 4. On this occasion, the CPU 1 sequentially issues instructions for four addresses in order to perform the tetrahedral interpolation for a single pixel. The first, second, third, and fourth instructed addresses are respectively compared with values in the first, second, third, and fourth address registers. The CPU 1 performs the tetrahedral interpolation for multiple pixels (e.g., a plurality of calculations). In other words, the comparator 5 can be a determination unit determining, with respect to each of the predetermined number of addresses, whether the address held in the address register for the previous calculation and the address instructed from the CPU 1 for the present calculation are the same as each other, when the CPU executes the plurality of calculations.

These compared resulted are held in the registers 11 corresponding to the respective address registers.

When the comparator 5 determines that the compared address is different from the corresponding value, the gate circuit 6 enables writing of the address from the CPU 1.

Upon receiving a signal (as shown by arrow D) from the activation register 8, the DMA unit 7 reads data in the address to be read out of the lookup table 21 (as shown by arrow B) and stores the read data in the data register 9 corresponding to the address register 4 (as shown by arrow C).

Each data register 9 is used for storing the result of reading the memory (the read data) with the DMA unit 7.

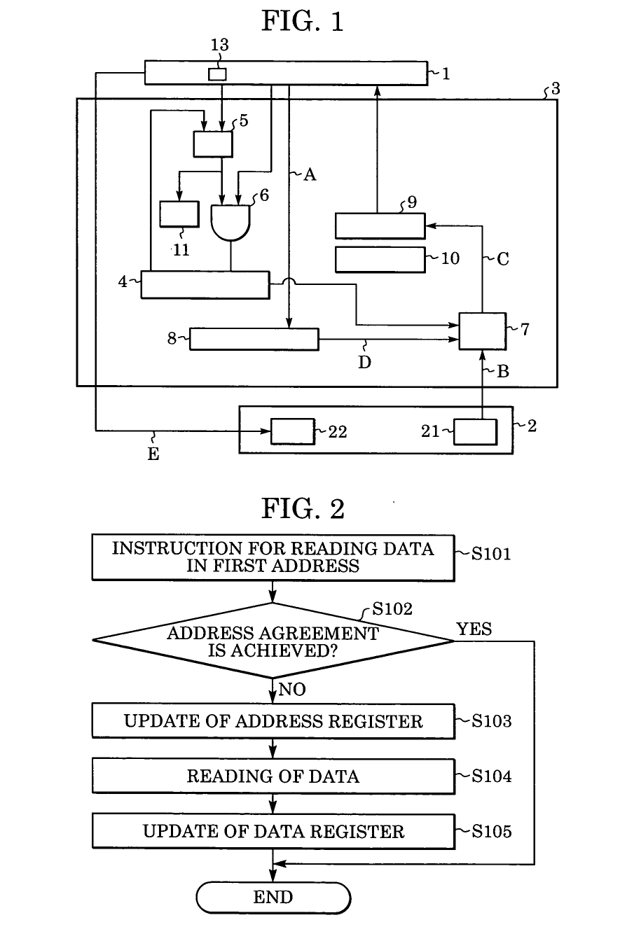

An operation of the main memory controller 3 will be described with reference to FIG. 2. The operation will be described with respect to the first instructed address. The controller 3 first receives an instruction from the CPU 1 to read data in the first address from the LUT 21 (S101). The instruction is for tetrahedral interpolation. Then, the comparator 5 of the controller 3 compares the value from the CPU 1 (the address to be read from the first address of the LUT 21) with the value in the first address register 4 (S102). The compared result is stored in the register 11.

In the case of address agreement as a result of the comparison, the process ends without performing a further process. In the case of address disagreement, the value in the first address register is updated (S103). That is, the value in the first address register 4 is updated on the value from the CPU 1. Then, upon receiving a trigger signal (as shown by arrow A indicated in FIG. 1) from the CPU 1, data stored in a specified address of the table 21 disposed in the main memory 2 is read (S104) and stored in the data register corresponding to the first address register (S105).

Since reading instructions for the second to fourth addresses are the same as that for the first address, their descriptions are omitted.

The register 10 indicating whether reading data has been completed will now be described. The register 10 has four flags, each indicating completion of reading the data corresponding to the four respective address registers. When the read process is actually performed, the corresponding flag is set. When all four flags are set, an end flag is set.

The CPU 1 performs polling of the end flag, and upon recognizing the end flag, presumes that the read process for a single pixel has been competed. After it is confirmed that the end flag is set, these flags are reset for use in the read process for the following single pixel.

The flags indicating completion of reading data are set in accordance with the compared results performed by the comparator 5. In other words, in the case of address agreement, the flag corresponding to the address is set. This means that, with respect to the address register not subjected to the read process, its flag is set under presumption that the corresponding data has been read. With this arrangement, all flags are set after completion of the read processes, whereby the read processes are easily administrated.

For example, as results of address comparison, when only the value held in the first address register agrees with the corresponding address, only the flag corresponding to the first address register is set. With respect to the other flags, when the respective read processes are actually performed, the corresponding flags are set.

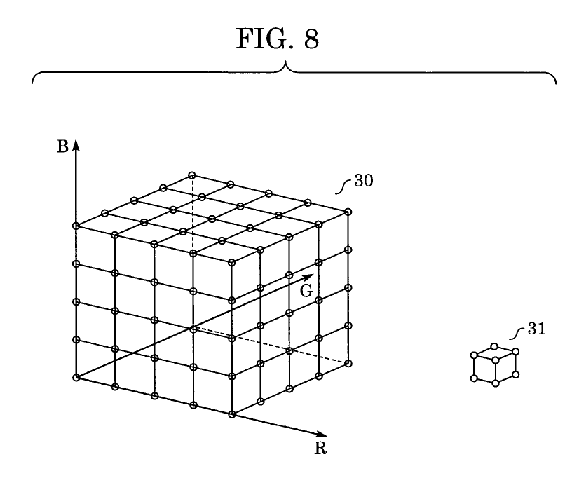

Referring to FIG. 8, the concept of the tetrahedral interpolation will be briefly described. A three-dimensional table 30 representing a RGB color space has 64 unit cubes 31. While the table 30 has 125 (5×5×5) lattice points (sampling points) in FIG. 8, the number of the points is not limited to this.

On the basis of color information, one of the 64 unit cubes is selected and four of eight lattice points (apexes) defining the unit cube are selected for every pixel. The lookup table has information (output values) of a C-component, an M-component, a Y-component, and a K-component held therein, corresponding to the respective lattice points. The tetrahedral interpolation is computed on the basis of the information on these four lattice points.

A comparing process in the process flow shown in the foregoing FIG. 2 and performed by the comparator 5 will now be described. For example, when the following calculation is performed, in the case where the color information has a different value from that of the previous pixel and a unit cube located away from the previously selected one is selected, all four lattice points are different from the previously selected ones. In this case, when compared as illustrated in FIG. 2, all addresses of the four address registers do not agree with the values in the corresponding address registers.

Even when the color information has a different value from that of the previous pixel, in the case where a unit cube identical to the previously selected one is selected, a part of the four lattice points are different from the previously selected ones. Hence, when the addresses are compared as illustrated in FIG. 2 with respect to the four address registers, a part of the addresses do not agree with the values in the corresponding part of the address registers.

With reference to FIG. 5, a process flow of the tetrahedral interpolation for a single pixel will be described. The CPU 1 sequentially issues requests for reading data in the first address (S501), data in the second address (S502), data in the third address, (S503), and data in the fourth address (S504).

Upon reading the data in the respective first to fourth data registers, the CPU 1 computes the tetrahedral interpolation (S505). Then, the CPU 1 stores the computed result in the computed-result area 22 of the main memory 2 via the cache memory 13 (as shown by arrow E indicated in FIG. 1).

The process shown in FIG. 5 is performed for every pixel. Accordingly, in order to apply the tetrahedral interpolation process to all pieces of JPEG (Joint Photographic Experts Group) image data of, for example, 300,000 pixels, the process must be performed 300,000 times.

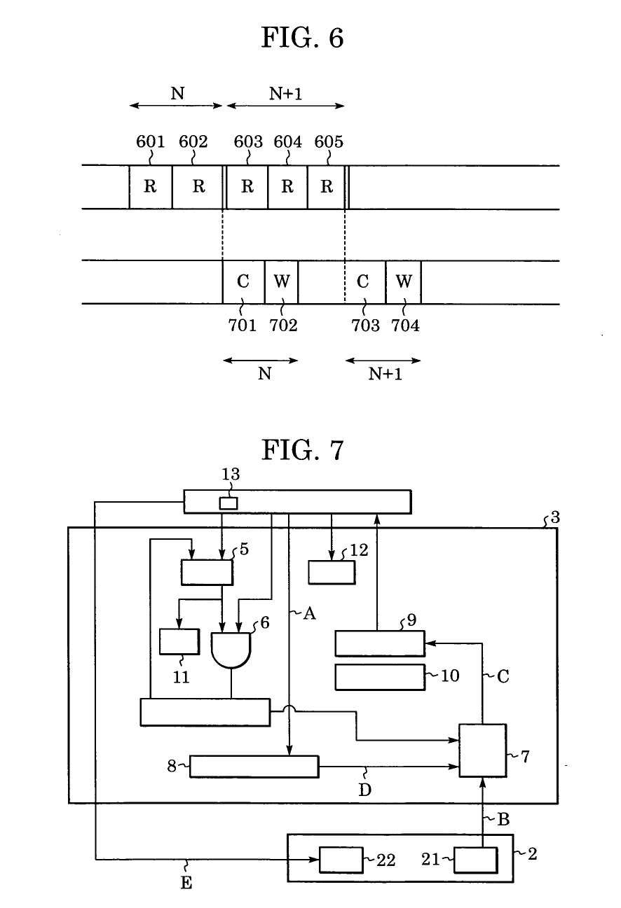

FIG. 6 illustrates timings for the read processes and calculation processes of the tetrahedral interpolation performed for every pixel.

For ease of explanation, processes of N-th and (N+1)-th pixels will be described.

In the process of the N-th pixel in which read of two addresses can be omitted, the read processes R of the two addresses are performed (during periods 601 and 602) by the DMA unit. After the read processes R, a calculation process C and a storage process W of the calculated result are performed (during respective periods 701 and 702) by the CPU 1. The storage process is performed using the cache memory 13.

In the process of the (N+1)-th pixel in which read of one address can be omitted, the read processes R of three addresses are performed (during periods 603 to 605) by the DMA unit.

While the CPU 1 performs the calculation process C and the storage process W of the n-th pixel, the DMA unit can read the following (N+1)-th pixel. As a result, a throughput of the tetrahedral interpolation process or the overall image process can be improved. After the read processes R of the (N+1)-th pixel, a calculation process C and a storage process W of the calculated result are performed (during respective periods 703 and 704) by the CPU 1.

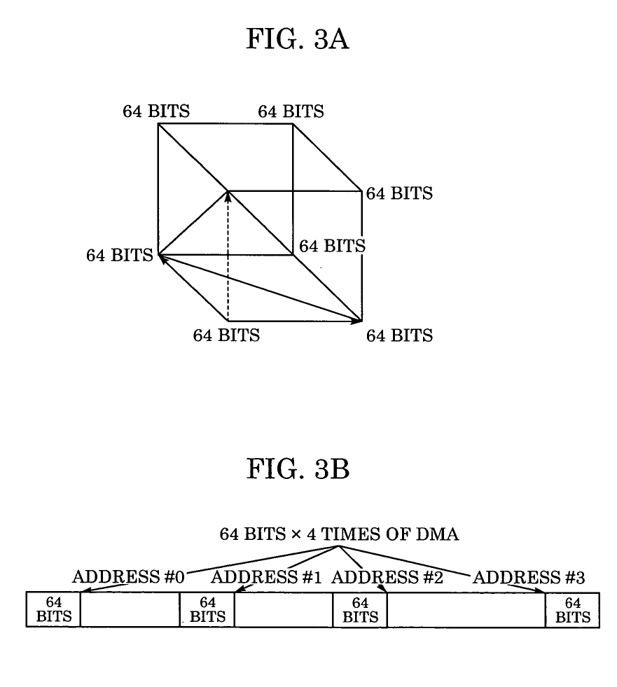

FIG. 3 illustrates an example application of memory access. FIG. 3A illustrates interpolation of a tetrahedron. In an RGB color process, the tetrahedron is used for processing image data for each pixel. Addresses correspond to the respective positions of the lattice points already illustrated in FIG. 8.

FIG. 3B illustrates the read process of 64-bit data performed by the DMA unit. The main memory 2 (e.g., an SD-RAM) illustrated in FIG. 1 has the lookup table (LUT) 21 stored therein for the tetrahedral interpolation.

The 64-bit data is read four times for each address on the basis of address values indicated by the address registers 4 shown in FIG. 1.

Addresses #0 to #3 denote address values stored in the first to fourth address registers, respectively.

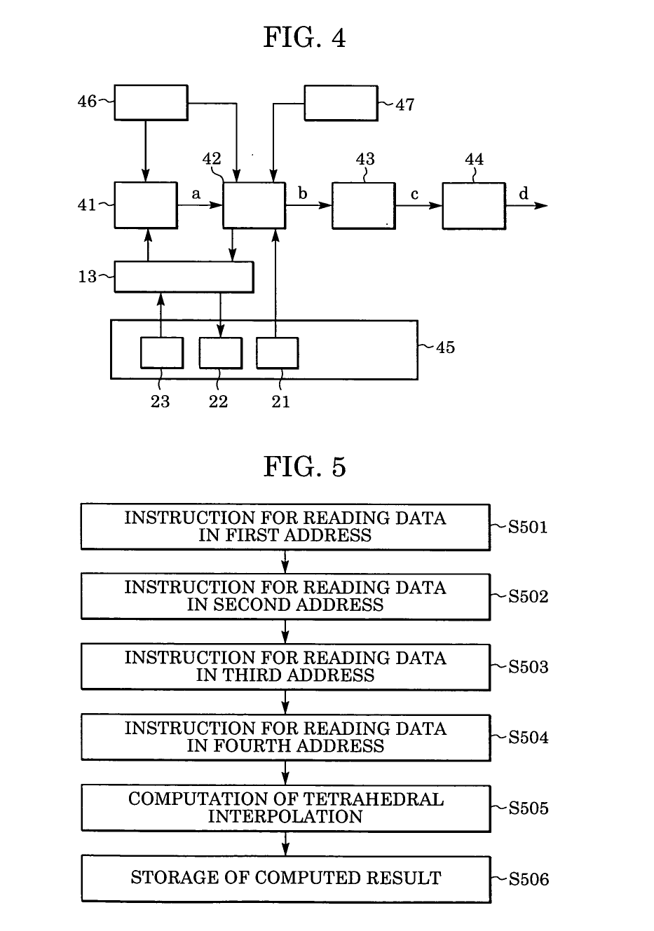

FIG. 4 illustrates image process blocks including the tetrahedral interpolation process of the electronic apparatus. The blocks include a color conversion unit 41 receiving JPEG image data stored in a receiving buffer 23 and applying color conversion on it (converting YcbCr color data to RGB color data).

The receiving buffer has data stored therein for every pixel in a predetermined color order, that is, in a so-called dot sequence. Accordingly, the data read from the receiving buffer is stored in the cache memory 13, is then read from the cache memory 13, and is subjected to a color conversion process.

The blocks also include a color process unit 42 converting data into 16-bit CMYK data and a magnification process unit 43 (converting data from 300 dpi to 600 dpi.

The blocks further include an error-diffusing unit 44. Data outputted from the error-diffusing unit 44 is converted so as to be suitable for a recording device and transferred to the recording device. A recording apparatus includes, for example, recording devices corresponding to respective data of C (cyan), M (magenta), Y (yellow), and K (black). If the recording devices constitute an inkjet head, ink is discharged onto a recording sheet of paper on the basis of the data.

Since the addresses to be read are not continuously located, the data stored in the main memory 2 is read by the DMA unit and inputted into the error-diffusing unit 44 without being stored in the cache memory 13.

The color process unit 42 includes a photo-optimizer unit, an auto-tone-control unit, an Adobe-RGB conversion unit, and so forth, other than the above-described tetrahedral interpolation unit.

The blocks still further include a main memory (an SD-RAM) 45 corresponding to the main memory 2 shown in FIG. 1 and including the lookup table (LUT) 21 for a tetrahedral interpolation, the area 22 for storing a computed result, and the receiving buffer 23 storing JPEG image data received from outside.

The blocks furthermore include a ROM 46 storing a table for converting, for example, YcbCr color data to RGB color data and an S-RAM 47.

The main memory 45, the ROM 46, and the S-RAM 47 are disposed in the ASIC together with the color conversion unit 41, the color-processing unit 42, the magnification-processing unit 43, and the error-diffusing unit 44.

Arrows (a, b, c, and d) in the figure indicate flows of data processed in the corresponding blocks, and arrows between each of the memories 45, 46, and 47 and each of the blocks indicate read/write of data, read of the table, or the like.

As described above, since the table to be read has a greater capacity than that of the cache memory, or the addresses to be read are discretely located, an image process which cannot be effectively performed by the table cache memory can be effectively performed. With this arrangement, a throughput of an image-processing circuit or an electronic apparatus can be improved.

More particularly, when the electronic apparatus serves as a recording apparatus, a throughput of the recording apparatus from receiving image data for one page to completion of recording it onto a recording sheet of paper (a recording medium) can be improved.

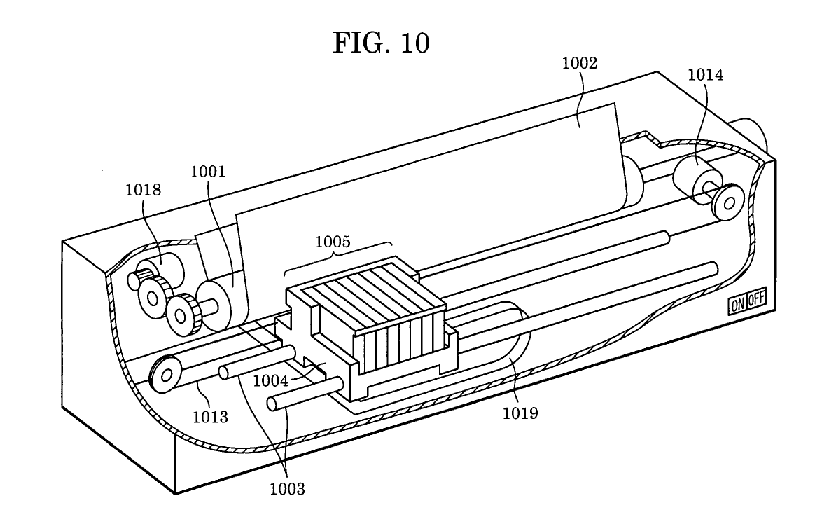

FIG. 10 is a perspective view of a recording apparatus serving as an example of the electronic apparatus. The recording apparatus includes a recording head 1005, which is mounted on a carriage 1004. The recording head is movable in a reciprocating manner along a shaft 1003 in its longitudinal direction.

Ink discharged from the recording head reaches a recording medium 1002, whose recording surface is regulated by a platen roller 1001 so as to have a fine gap against the recording head, and forms an image on the surface.

The recording head is supplied with a discharge signal in accordance with image data via a flexible cable 1019. The recording apparatus also includes a carriage motor 1014 allowing the carriage 1004 to scan along the shaft 1003, a wire 1013 transferring a drive force of the motor 1014 to the carriage 1004, and a transport motor 1018 in connection with the platen roller 1001, for transporting the recording medium 1002.

The recording apparatus performs recording by allowing the recording head to carry out a single scan and a predetermined amount of transport operation. With this structure, the above-described image-processing circuit executes processing of an image in accordance with an amount of data used, for example, in a single scan.

### Second Embodiment

A second embodiment will now be described. Descriptions of like parts as in the first embodiment are omitted.

FIG. 7 is a block diagram of an electronic apparatus according to the second embodiment. Different parts from those shown in FIG. 1 are described. The electronic apparatus according to the second embodiment includes a read enable (permit) register 12. The read permit register 12 includes flags corresponding to the respective address registers, and with respect to the address register at which the corresponding flag is set, its data is read from the main memory 2 even when the corresponding address outputted from the CPU 1 agrees with that held in the address register.

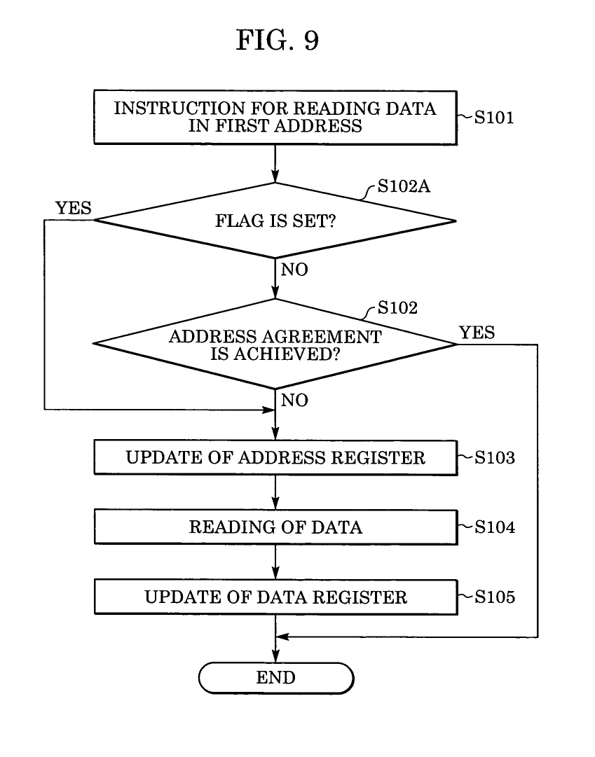

FIG. 9 illustrates a control flow of the electronic apparatus according to thé second embodiment, and only different parts from those shown in FIG. 2 will be described, while descriptions of like parts as those in FIG. 2 are omitted.

When the flag of the read permit register 12 is set (YES in S102A), the process moves to step S103, and the corresponding address register is updated. That is, even in the case of address agreement, the steps S103 through S105 are carried out.

In other words, when the flag of the read permit register 12 is set, steps S103 through S105 are carried out regardless of address agreement/disagreement of the address.

When the flag of the read permit register 12 is not set (NO in S102A), the process moves to step S102, and it is determined whether the address agreement is achieved.

As described above, with respect to the address register at which the corresponding flag of the read permit register 12 is set, its data is always read from the main memory 2. In the same fashion as in the first embodiment, the same process is performed with respect to the second, third, and fourth address registers.

For example, in the case where all flags of the read permit register 12 are set, even when the address values respectively held in the four address registers agree with those outputted from the CPU 1, data is read from the table 21 of the main memory 2 in accordance with addresses of the corresponding address registers.

The reason for making such a structure is that contents of the table to be read are sometimes changed. In this case, when values of data held in the table are different from each other even in the same address, data held in the data registers is different from that held in the table, whereby color conversion cannot be correctly performed.

The change of the contents of the table is performed in accordance with change of image-processing modes. When the electronic apparatus serves as a recording apparatus, the table is changed in accordance with change of kinds of recording media or recording modes.

As described above, not only a throughput of the overall image process or a control of an electronic apparatus is improved, but also, even when data held in a memory to be read is changed on the way of processing, a proper control is carried out since the change can be coped with.

### Other Embodiments

While the tetrahedral interpolation is processed with four addresses in the above-description, the present invention is not limited to this and is also applicable to a hexahedral interpolation process and so forth.

When the above-described electronic apparatus serves as a recording apparatus, the block controlling transfer of data to the recording head, the block controlling drive of the recording head, and the like may be incorporated into the above-described ASIC. Also, the CPU 1 and the main memory 2 may be incorporated into the ASIC.

As examples of the electronic apparatus, an image reading apparatus, a copying machine, and the like are listed other than the above-described recording apparatus. The electronic apparatus is not limited to a type connected to a host apparatus and receiving image data from the host apparatus, but it may be another type including a memory slot to which a memory card is accessible and directly receiving data without passing through the host apparatus.

While the present invention has been described with reference to exemplary embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-191638 filed Jun. 29, 2004, which is hereby incorporated by reference herein in its entirety.

1. An image-processing circuit, comprising:
a memory including a data table for a plurality of calculations;
a central processing unit executing the plurality of calculations; and
a memory controller controlling read of data from the data table upon receiving an instruction from the central processing unit,
wherein the memory controller includes
address registers holding a predetermined number of addresses read from the data table for use in a single calculation;
data registers corresponding to the respective address registers and holding data corresponding to the addresses held in the address registers;
a determination unit determining, with respect to each of the predetermined number of addresses, whether the address held in the address registers for a previous calculation and an address instructed from the central processing unit for a present calculation are the same as each other; and
a control unit, when the determination unit determines that the address for the present calculation is the same as the previous address, reading data from the data register corresponding to the address register holding the address, and, when the determination unit determines that the address for the present calculation is different from the previous address, reading data from the memory, and
wherein the central processing unit executes the plurality of calculations on the basis of data received from the memory controller.

2. An image-processing circuit according to claim 1, wherein the central processing unit includes a cache memory and stores the result of the plurality of calculations in the cache memory.

3. An image-processing circuit according to claim 2, further comprising a color converter converting JPEG data into RGB data,
wherein the memory includes a buffer for storing the JPEG data, and
wherein the color converter stores the JPEG data in the cache memory when reading the data.

4. An image-processing circuit according to claim 1, wherein the calculation is carried out for a tetrahedral interpolation.

5. An image-processing circuit according to claim 1, wherein the calculation is carried out for converting RGB data into CMYK data.

6. An image-processing circuit according to claim 1, wherein, in a case where the data table is changed, the memory controller stores the address instructed by the central processing unit in the address register regardless of the determination of the determination unit.

7. The circuit according to claim 1, wherein the data table is changed in accordance with change of process modes of the image-processing circuit.

8. An image-processing circuit, comprising:
a memory storing information about a three-dimensional space;
a central processing unit executing a plurality of calculations; and
a memory controller controlling read of data from the memory upon receiving an instruction from the central processing unit,
wherein the memory controller includes
first registers holding positional information of a predetermined number of lattice points of the three-dimensional space received from the memory for use in a single calculation;
second registers holding information corresponding to the respective first registers and holding the positional information of the lattice points held in the corresponding first registers;
a determination unit determining, with respect to each of the positions of the lattice points held in the first register, whether the position held in the first registers for a previous calculation is the same as a position instructed from the central processing unit for a present calculation; and
a controller, when the determination unit determines that the position for the present calculation is the same as the position for the previous calculation, reading data from the second register corresponding to the first register holding the corresponding positional information, and when the determination unit determines that the position for the present calculation is different from the position for the previous calculation, reading data from the memory, and
wherein the central processing unit executes the plurality of calculations on the basis of data received from the memory controller.

9. An electronic apparatus comprising the image-processing circuit according to claim 5, wherein a recording operation is performed on a recording medium using a recording head on the basis of the CYMK data.

10. A method for processing an image, using a memory including a data table for a plurality of calculations a central processing unit executing the plurality of calculations and a memory controller controlling read of data from the data table upon receiving an instruction from the central processing unit, the method comprising steps of:
outputting a predetermined number of address information to be read to the memory on the basis of inputted color space information;
determining, with respect to each of the predetermined number of addresses, whether the address used in a previous calculation and an address instructed from the central processing unit for a present calculation are the same as each other;
reading data, with respect to the addresses which are determined in the determining step to be the same or different from the previous address, from a data register corresponding to an address register holding the address and from the memory respectively; and
performing the plurality of calculations on the basis of the data read in the reading step.
